(19) United States
(12) Patent Application Publication
(10) Pub. No.: US 2014/0052564 A1
(43) Pub. Date: Feb. 20, 2014

(54) Notarized Game Card and Achievement Card

(71) Applicant: Robb Lewis, Los Gatos, CA (US)

(72) Inventor: Robb Lewis, Los Gatos, CA (US)

(21) Appl. No.: 13/970,498

(22) Filed: Aug. 19, 2013

Related U.S. Application Data
(60) Provisional application No. 61/684,667, filed on Aug. 17, 2012.
(60) Provisional application No. 61/684,670, filed on Aug. 17, 2012.

(51) Int. Cl. G06Q 30/06

(52) U.S. Cl. CPC G06Q 30/0621
USPC 705/26.5

(57) ABSTRACT

Systems and methods are provided for customizing a payment device with a video game related image. One such method comprises receiving, at an online store executing on a computer including a computer readable medium and processor, an achievement message indicating an achievement earned by a user and further including an achievement image and user data. The method further comprises receiving, at the online store, a request from the user to purchase a payment device. The request indicates the achievement image associated to be displayed on the payment device. The method further comprises generating, by the online store, a representation of the payment device configured to display the achievement image.

### CROSS-REFERENCES TO RELATED APPLICATIONS

This application is related to U.S. Provisional Patent Application No. 61/684,667, filed on Aug. 17, 2012, titled “NOTARIZED GAME CARD,” by Robb Lewis; and to U.S. Provisional Patent Application No. 61/684,670, filed on Aug. 17, 2012, titled “Prepaid Achievement Card,” by Robb Lewis, each of which is herein incorporated by reference in its entirety for all purposes.

### BACKGROUND

Themed or customized payment cards represent one way of showing affiliations and interests. For example, a person may choose to get a credit card with a picture of their favorite sports team, their university, their family, or their favorite place to visit. Video games, and in particular online video games such as massively multiplayer online role playing games, increasingly represent a strong subculture, both online and in the real world. Payment transactions occur regularly online within various online video games, however, presently, themed payment cards do not typically address this population group. Embodiments of the invention address these and other problems.

### BRIEF SUMMARY

Systems and methods are provided for customizing a payment device with a video game related image. One such method comprises receiving, at an online store executing on a computer including a computer readable medium and processor, an achievement message indicating an achievement earned by a user and further including an achievement image and user data. The method further comprises receiving, at the online store, a request from the user to purchase a payment device. The request indicates the achievement image associated to be displayed on the payment device. The method further comprises generating, by the online store, a representation of the payment device configured to display the achievement image.

In accordance with an embodiment, a system for customizing a payment device with a video game related image comprises a host computer comprising a computer readable storage medium and processor. The host computer includes an image catalog, and the host computer is configured to receive a selection of an image to be printed on a payment device from a client computer. The host computer is further configured to receive a request to purchase a payment device, wherein the request indicates an image to be displayed on the payment device, notarize a representation of the payment device configured to display the image, and associate the payment device and the representation of the payment device with a user account. The system further includes a client computer comprising a display component configured to display images in the image catalog, receive the selection of the image and send the selection of the image to the host computer.

In accordance with an embodiment, a server computer comprises a computer readable storage medium and processor. The server computer further comprises an image catalog, which is a database including a plurality of images. The server computer further includes an online store, executing on the server computer. The online store is configured to receive a selection of an image to be printed on a payment device, and receive a request to purchase a payment device. The request indicates an image to be displayed on the payment device. The online store is further configured to notarize a representation of the payment device configured to display the image, and associate the payment device and the representation of the payment device with a user account.

### BRIEF DESCRIPTION OF THE DRAWINGS

FIG. 1 shows a system for purchasing a payment device with a customizable video game image through an online store and notarizing a representation of the payment device, in accordance with an embodiment of the invention.

FIG. 2 shows an online store for purchasing a payment device with a customizable video game image, in accordance with an embodiment of the invention.

FIG. 3 shows an image catalog, in accordance with an embodiment of the invention.

FIG. 4 shows a system for purchasing a payment device with a video game achievement image, and generating a notarized representation of the payment device, in accordance with an embodiment of the invention.

FIG. 5 shows a notarized representation of a payment device including a video game achievement image, in accordance with an embodiment of the invention.

FIG. 6 shows a method of purchasing a payment device with a customized video game image, in accordance with an embodiment of the invention.

FIG. 7 shows a method of purchasing a payment device with a video game achievement image, in accordance with an embodiment of the invention.

FIG. 8 shows a publisher-specific catalog tool, in accordance with an embodiment of the invention.

FIG. 9 shows an embeddable user card collection tool, in accordance with an embodiment of the invention.

FIG. 10 shows a block diagram of a system according to some embodiments provided herein.

FIG. 11 shows a block diagram of an exemplary system comprising a server computer in accordance with some embodiments of the invention.

FIG. 12 shows an exemplary computer apparatus in accordance with some embodiments of the invention.

FIG. 13 shows an exemplary mobile device in accordance with some embodiments of the invention.

FIG. 14 shows an exemplary payment device in the form of card in accordance with some embodiments of the invention.

### DETAILED DESCRIPTION

The following disclosure may provide exemplary systems, devices, and methods for conducting a financial transaction and related activities. Although reference, may be made to such financial transactions in the examples provided below, embodiments are not so limited. That is, the systems, methods, and apparatuses described herein may be utilized for any suitable purpose.

Before discussing specific embodiments and examples, some descriptions of terms used herein are provided below.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment, but other elements may be added and still form a construct within the scope of a claim. In contrast, the transitional phrase “consisting of” excludes any element, step, or ingredient not specified in a claim. This is consistent with the use of the term throughout the specification.

As used herein, an “electronic wallet” or “digital wallet” can store user profile information, payment information, bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like.

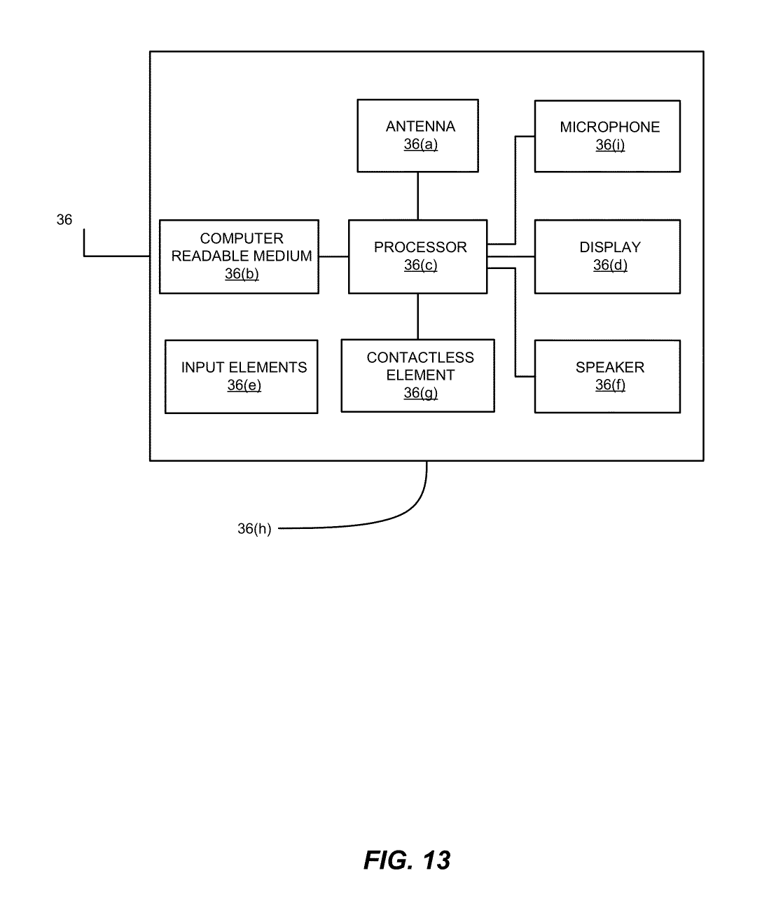

As used herein, a “mobile device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. A mobile device may comprise any suitable hardware and software for performing such functions, and may also include multiple devices or components (e.g. when a device has remote access to a network by tethering to another device—i.e. using the other device as a modem—both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below with reference to FIG. 13.

As used herein, an “online purchase” can be the purchase of a digital or physical item or service via a network, such as the Internet.

As used herein, a “payment account” (which may be associated with one or more payment devices) may refer to any suitable payment account including a credit card account, a checking account, or a prepaid account.

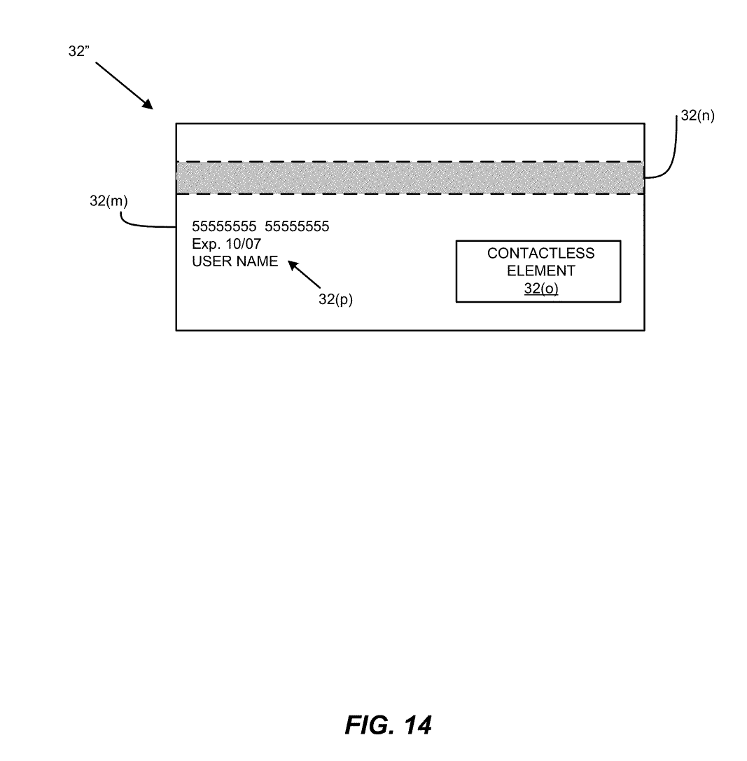

As used herein, a “payment device” may refer to any device that may be used to conduct a financial transaction, such as to provide payment information to a merchant. A payment device may be in any suitable form. For example, suitable payment devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of payment devices include cellular phones, personal digital assistants (PDAs), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode. An exemplary payment device is described below with reference to FIG. 14.

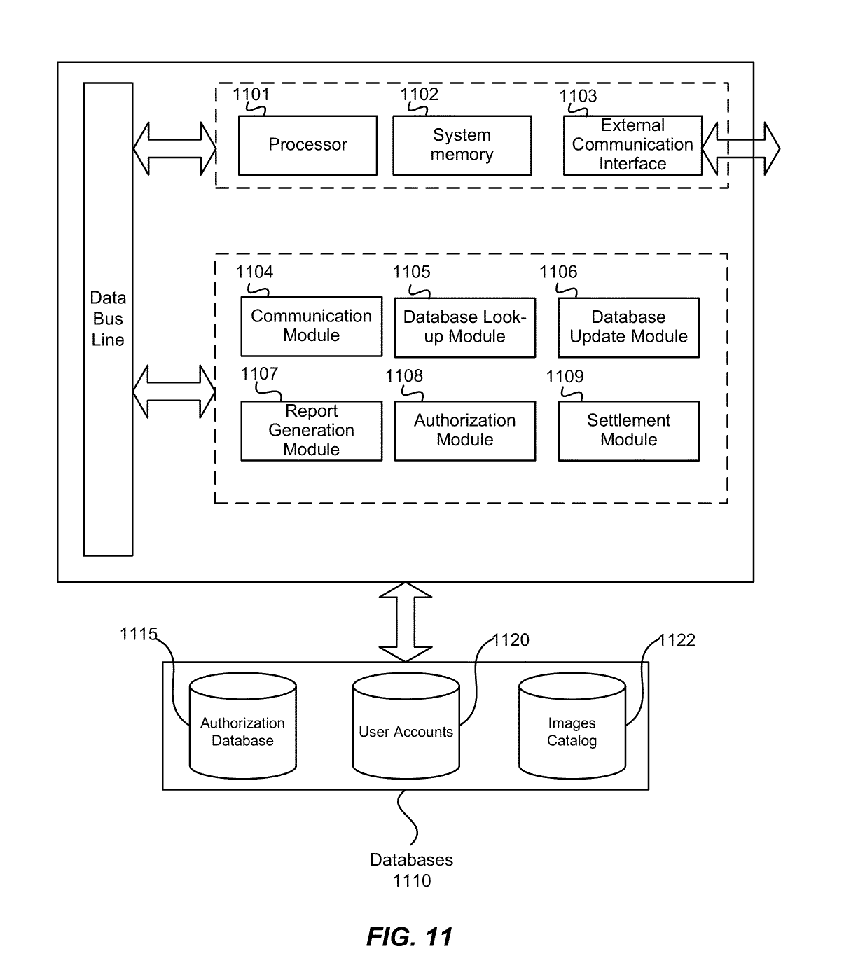

As used herein, a “server computer” is typically a powerful computer or cluster of computers. For example, the server computer can be a large mainframe, a minicomputer cluster, or a group of servers functioning as a unit. In one example, the server computer may be a database server coupled to a Web server. An example of a server computer is described in FIG. 11.

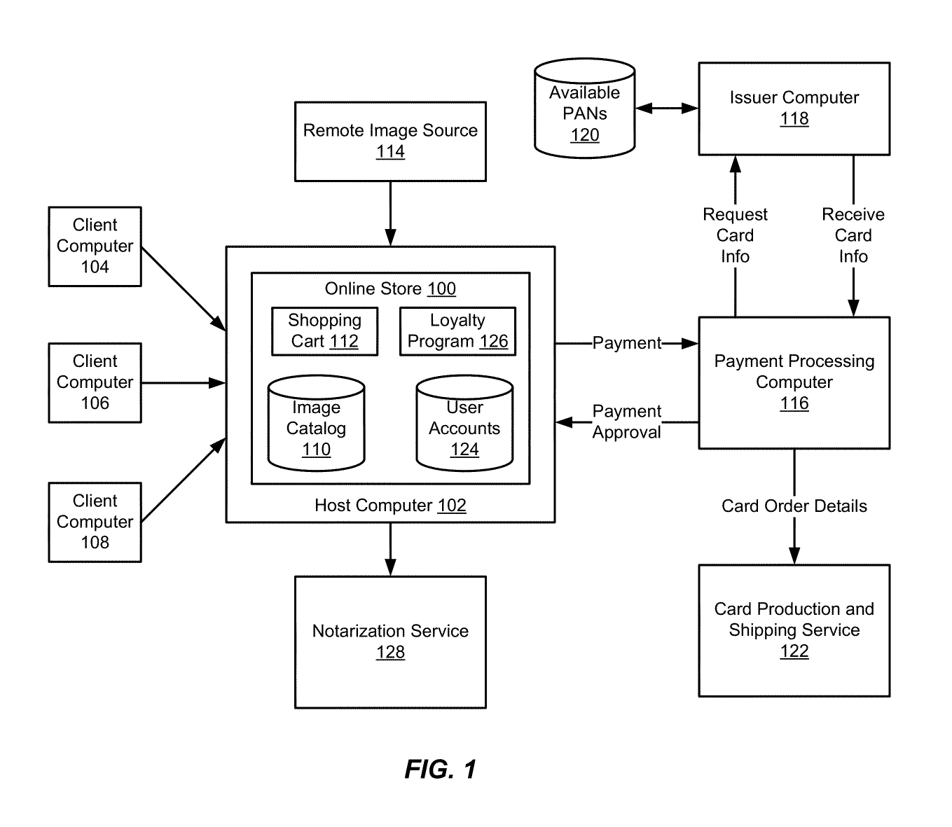

FIG. 1 shows a system for purchasing a payment device with a customizable video game image through an online store and notarizing a representation of the payment device, in accordance with an embodiment of the invention. As shown in FIG. 1, an online store 100 executing on a host computer 102 can be used to sell customized payment devices, such as payment cards featuring custom designs, to users. Users can access the host computer 102 through a web browser on one of a plurality of client computers 104-108 that are connected to the host computer via a network, such as the Internet. In accordance with an embodiment, a user can purchase one or more payment devices through the online store. In accordance with an embodiment, the payment devices can be prepaid, reloadable debit or credit cards. The user can view available images stored in an image catalog 110, select an available image, and add the selected image to a shopping cart 112. In some embodiments, the image catalog can be stored locally on the host computer 102 and can include images populated by one or more content publishers, such as video game developers and video game publishers. In some embodiments, images can be received from a remote image source 114, such as an image repository hosted at a publisher's computer or directly from a user's video game system, as is further described below.

Once the user has selected their desired image, the user can checkout to complete the purchase. The checkout process can include providing payment information, such as payment account details, to the online store which then forwards the payment information to a payment processing computer 116. If the payment transaction is successful, the payment processing computer 116 can request card information for the payment device from an issuer computer 118. The issuer computer 118 can assign a primary account number (PAN) to the payment device from a database of available PANs 120. The issuer computer 118 can then return the assigned PAN to the payment processing computer 116. In accordance with an embodiment, the payment processing computer 116 can then send a plurality of card order details to a card production and shipping service 122. For example, the plurality of card order details can include the selected image, the PAN assigned by the issuer computer 118, a user name to be printed on the payment device, and a shipping address for the payment device. In accordance with an embodiment, the payment processing computer can extract the shipping address and user name from the payment details received from the online store. In some embodiments, the payment processing computer 116 can send a request for the user name and shipping address to the online store with a payment approval message. The payment processing computer 116 can send the card order details to the card production and shipping service 122 with an instruction to print the payment device configured to display the selected image (e.g., printed on a physical payment card) and mailed to the user. In addition to having the payment device mailed to the user, the online store can also provide a notarized, sharable, virtual representation of the newly purchased payment device.

When the payment has been approved by the payment processing computer 116, the payment processing computer 116 can send a message to the online store indicating that the purchase was successful. Upon receiving this message, the online store can generate a representation of the payment device being sent to the user, and link the representation of the payment device to the user's account 124. The representation of the payment device can show the payment device as it is received by the user. For example, it can show the selected image printed on a representation of the physical card, complete with the user's name, and an account number alias or a masked account number. A record of the transaction and an associated loyalty value can also be stored in a loyalty program 126 associated with the user's account 124. The loyalty program can access the information stored in the image catalog and user accounts databases. The loyalty program can track statistics about each user, such as in-game achievements, points acquired, community information and leaderboards based on information stored in the user accounts database. A plurality of events can be defined for the loyalty program, and each event can be associated with a number of loyalty points. In some embodiments, the loyalty program can access in-game statistics, such as game points or in-game currency held by a user. The loyalty program can include a conversion rate for each game to convert the in-game statistics into loyalty points. The loyalty points can then be used to purchase out-of-game items such as customized gift cards, as discussed further below.

In accordance with an embodiment, when the online store generates the representation of the payment device, it can “notarize” the representation in such a way that the representation can be authenticated as having been purchased by the user. The notarization can be performed by embedding personal data into the image, such as through a visible watermark, personalized tags, and/or a unique random number generated based on the user's personal data embedded in the representation's code. This effectively affixes a certificate of authenticity to the representation. This helps deter other users from misappropriating the images in the images catalog to misrepresent their possession of a payment device featuring a particular image. In some embodiments, the online store can send a copy of the representation to a notarization service 128 to notarize the representation. Additionally, or alternatively, the notarized representation can be authenticated by a third party authentication service such that if the notarized representation is selected (e.g., clicked by a user when viewed in a browser), an authentication message can be displayed indicating that the notarized representation is authentic.

By officially endorsing the representations, the online store can introduce a scarcity metric to the purchasing process. The online store, or each individual publisher, can assign a scarcity metric to each image in the image catalog. Each scarcity metric can represent a predetermined limit on the number of payment devices which can be sold featuring a particular image from the images catalog. The scarcity metric can represent a fixed number of payment devices, and/or a fixed time period during which the image is available. The scarcity metric can be adjusted to coincide with offer periods or new releases of video games and related media such as film, video or novel adaptations. For example, if a new release is scheduled for a particular date, then the predetermined limit can be reset and a new batch of cards can be released. In accordance with an embodiment, the scarcity metric for each image can be stored in the image catalog or in a separate table or data structure that is linked to the image catalog.

For example, a limit of 1000 payment devices can be associated with a particular image from a particular video game to coincide with the release of the video game. When those 1000 payment devices have been issued, the image is no longer available. When an image's scarcity metric has been exhausted, the image can be removed from the image catalog, greyed out within the image catalog, or otherwise made not selectable from the image catalog. Subsequently, a sequel to the video game is released. The publisher or the online store can then reset the predetermined limit and enable an additional 1000 payment devices to be issued to coincide with the release of the sequel. To retain the scarcity value of the image, the notarization information embedded in each payment device can include information indicating to which release or edition the payment device belongs. This can be accomplished through a date stamp, serial number, or other encoded information within the notarization information of each representation.

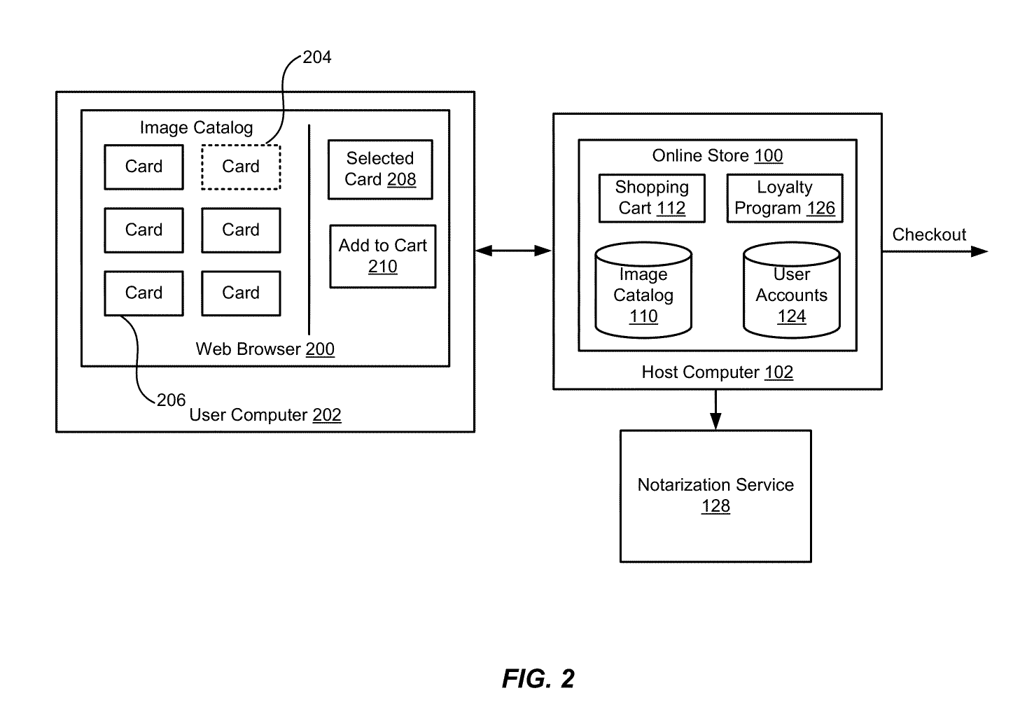

FIG. 2 shows an online store for purchasing a payment device with a customizable video game image, in accordance with an embodiment of the invention. As shown in FIG. 2, the online store 100 can interface with one or more users through a web browser 200 or dedicated application executing on a user's personal computer 202 or mobile device. The online store can execute on a server computer, or a cluster of server computers, such as that described below with reference to FIG. 11. As described above, the online store 100 can further include an image catalog 110 and a user accounts database 124. The online store 100 can communicate transactions to a payment processing computer 116 which, when payments have been approved, can forward order information to a fulfillment service to generate and ship the purchased payment device to the user.

As shown in FIG. 2, a user can view the images stored in the image catalog 110 in a web browser 200. In some embodiments, the user can select an image 204 to be printed or otherwise displayed on a payment device. Selectable images 206 can be viewed by the user through a web browser or dedicated application in one or more catalogues in the online store. After selecting an image, the user can view a preview of the selected image 208 and add the payment device and selected image to a shopping cart 210 and proceed to checkout. In some embodiments, the user can indicate an amount to be loaded on the new payment device. The online store can send a request to the user for their payment information in the checkout process. Checkout can be performed by the online store itself, or the user can be redirected to a third-party payment system. As described above, if the payment is approved by the payment processing computer 116, then the user's order is sent to an on-demand fulfillment service which can generate the payment device and configure it to display the selected image (e.g., printing a new payment card with the selected image on the front and/or back). The payment device can then be loaded with the funds indicated by the user during checkout and mailed to the user. A notarized representation of the payment device can also be provided to the user and associated with their account, as described above with respect to FIG. 1.

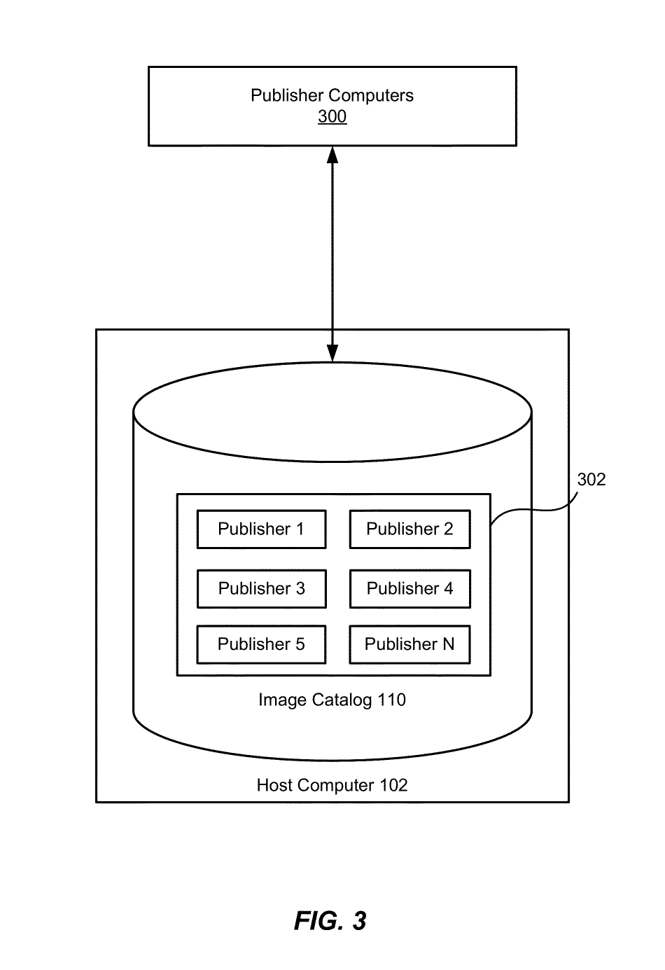

FIG. 3 shows an image catalog, in accordance with an embodiment of the invention. The image catalog 110 can include one or more distinct image catalogs, e.g., an image catalog for each video game publisher, developer, and/or video game. Each catalog can include pre-defined video game related images such as characters, weapons, locations, or other notable, or readily identifiable images. These images can be grouped within the images catalog database by theme, genre, publisher or other organizational scheme within each catalog or across multiple catalogs. The images made available to users through the catalog can be predefined by video game publishers or developers. For example, a plurality of publisher computers 300 can populate the image catalog with images selected by the publisher. As described above, each publisher can define scarcity metrics for their images, limiting the number of cards that can be purchased featuring a given image, or making the image available for a limited time. In some embodiments, the online store can track how many times each image is selected in a given time period (e.g., weekly, monthly, etc.). Based on this information, images within each catalog can be sorted based on popularity. In some embodiments, this information can be used by the online store to retire, or rotate out, images from the images catalog which are no longer selling well. This can reduce clutter within the images catalog and reduce the processing requirements of maintaining an ever-increasing images catalog.

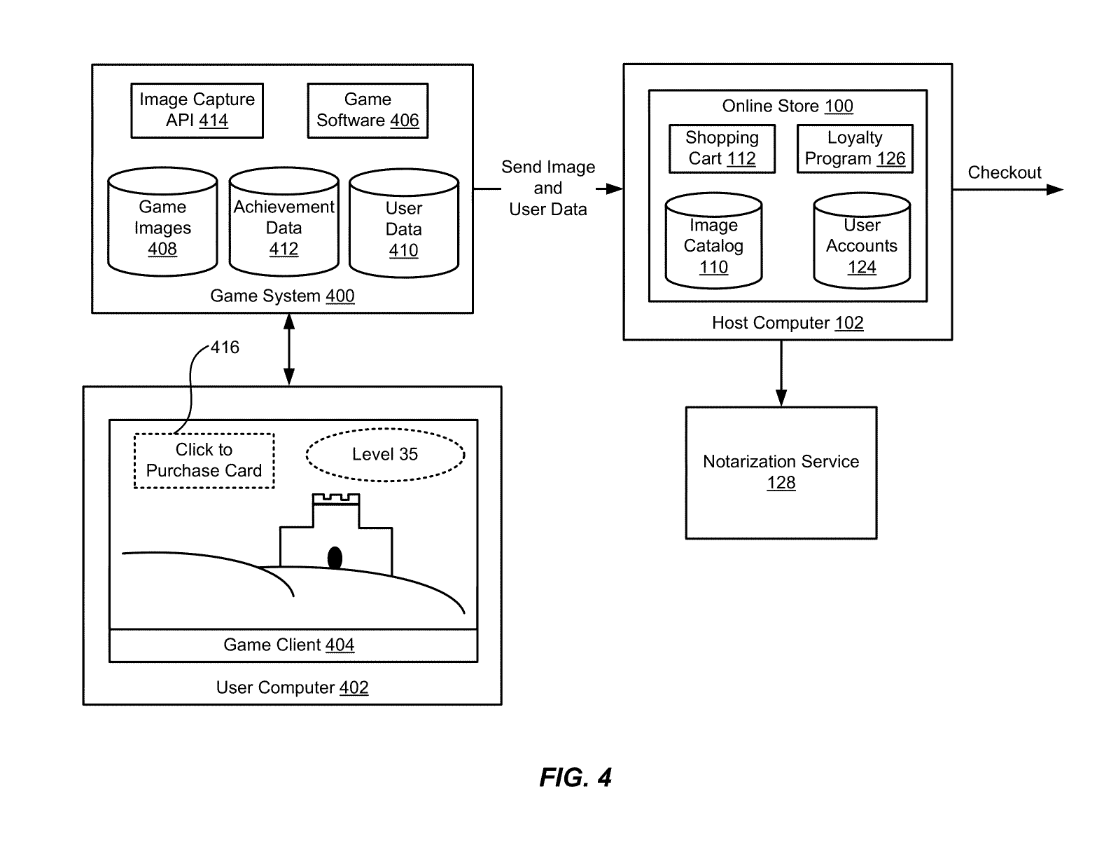

FIG. 4 shows a system for purchasing a payment device with a video game achievement image, and generating a notarized representation of the payment device, in accordance with an embodiment of the invention. As shown in FIG. 4, the online store 100 can be configured to receive information from a video game system 400, as a user plays the video game. In some embodiments, a user can play a video game on a personal computer 402 or mobile device in communication with the game system. A video game client 404 can execute locally on the user's computer 402 and communicate with game software 406 executing remotely on game system 400. Video games often define achievements or goals. These achievements can be used to indicate the user's progress within the game's story arc and/or can demonstrate a level of skill possessed by the user independent of the game's primary storyline or progression. For example, an achievement can be awarded for increasing a character's level to a predefined level, or completing a difficult quest. Achievements can also be awarded for time-intensive tasks which demonstrate completion of aspects of the game, such as exploring a particular percentage of the game's map or discovering a particular number of items.

In accordance with an embodiment, game systems, such as game platforms and/or game consoles, can monitor player achievements as the player progresses through the game. The game system can send an achievement message to the online store indicating which achievements have been awarded to the user. The achievement messages can be formatted according to a published standard, such as an application programming interface (API), by the online store. The achievement message can include an achievement image captured live by the game system, an achievement image stored at the game system in a game images database 408 and/or an image identifier for an image stored in the image catalog 110. The achievement message can also include user data 410 that identifies the user and/or a description of the achievement 412. In some embodiments, the user data can include payment data that was previously provided by the user to the game system. The online store can save achievement information associated with each user received from the game system in the user account database.

For example, if the user successfully discovers every item in a game and gains an item achievement, an image of a particularly rare item can be provided for the user. Similarly, if the achievement relates to successfully defeating a particular enemy, an image of the defeated enemy can be provided, or an image of the user's character during the battle with the particular enemy can be captured and provided. The achievement images can be stored in the game images database which can be populated with images from each game by the game publishers which are related to each achievement. In some embodiments, when the user accesses achievement images through the online store, the user can only see those achievement images which correspond to achievements the user has earned (i.e., those achievement images corresponding to image IDs received from the game system). In some embodiments, game system 400 and/or game software 406 can include an image capture API 414 that is operable to capture a live image from a video game and format the live image so that it can be sent to the online store 100 to be printed on a payment device.

In accordance with an embodiment, a link 416 to the online store can be provided to the user in-game when an achievement is awarded, enabling the user to view and/or purchase a payment device featuring the image. Additionally, or alternatively, the game system can send achievement messages to the online store in the background, without disrupting the user in-game. A passive notification can be provided to the user in-game which requires no action on the user's part at that time, but makes the user aware that an achievement image has been unlocked in the online store. For example, when the user is notified that an achievement has been earned, the message displayed in-game can also include a notification that the achievement image is available and inviting the user to visit the online store. This way, the user is made aware of this feature, but is not required to immediately stop playing the game and visit the online store. Thereafter, when the user next accesses the online store, the online store can notify the user that one or more new images have been unlocked and are now available. When the user initiates a transaction to purchase a payment device, the user will be able to select from the images stored in the images database as well as the achievement images unlocked by the user. After selecting an image, the transaction is sent to a payment processing computer 116 . When the payment is approved by the payment processing computer 116 and the card is successfully purchased, the payment processing computer 116 can have the payment device configured to display the selected image (e.g., printed on a physical payment card) and mailed to the user. Additionally, the online store can provide a notarized, sharable, virtual representation of the newly purchased payment device and/or a notarized, sharable copy of an achievement image unlocked by the user.

As described above with respect to FIG. 1, when the payment has been approved by the payment processing computer 116, the payment processing computer 116 can send a message to the online store indicating that the purchase was successful. Upon receiving this message, the online store can generate a representation of the payment device being sent to the user, and link the representation of the payment device to the user's account.

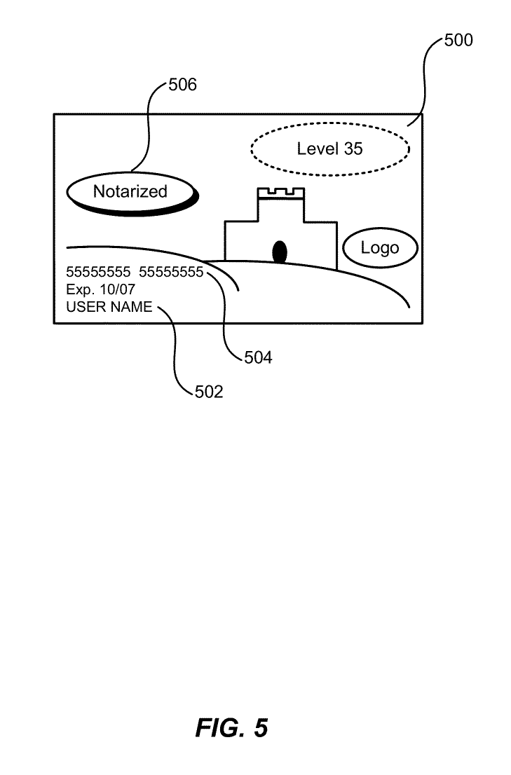

FIG. 5 shows a notarized representation of a payment device including a video game achievement image, in accordance with an embodiment of the invention. The representation of the payment device shows the payment device as it is received by the user. For example, it can show the selected image 500 printed on a representation of the physical card, complete with the user's name 502, and an account number alias or a masked account number 504. The notarized representation can include embedded personal data into the image, such as through a visible watermark 506 or personalized tags embedded in the representation's code. This effectively affixes a certificate of authenticity to the representation. As described above, this helps deter other users from misappropriating achievement images unlocked by other users to misrepresent their own achievements. Prevalence of these authenticated achievement images can be determined based on the difficulty of the associated achievement and the popularity of the video game. For example, difficult achievements in obscure video games will be more rarely represented than easy achievements in popular video games. In some embodiments, scarcity of some achievement images can be increased by the online store, or each individual publisher, by setting a predetermined limit on the number of payment devices which can be sold featuring a particular achievement image. The predetermined limit can represent a fixed number of payment devices, or a fixed time period during which the achievement image is available. For example, following a new release of a video game, the first thousand users to complete a particular achievement can purchase a payment device featuring an associated achievement image and receive a notarized copy of the achievement image to share. Similarly, a three month time period could be set during which every user to earn an achievement can purchase a payment card and receive a copy of an associated notarized achievement image.

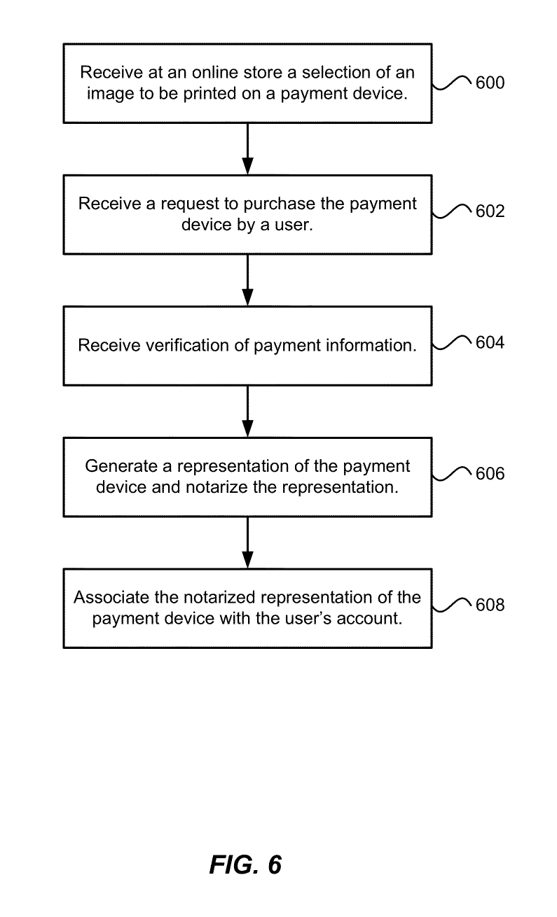

FIG. 6 shows a method of purchasing a payment device with a customized video game image, in accordance with an embodiment of the invention. At step 600, an online store receives a selection of an image to be printed on a payment device. The selection can be received from a client computer that is accessing the online store through a web browser executing on the client computer. At step 602, the online store can receive a request to purchase a payment device featuring the selected image. The request can include adding the selected image to a shopping cart and selecting a link to checkout. During the checkout process, the user can be prompted to provide payment information. In some embodiments, the user can redeem loyalty points obtained based on in-game actions, previous payment device purchases, payment device usage, or other related events, to obtain the payment device. At step 604, the payment information can be verified. For example, a payment processor computer can receive the payment information and process the transaction. If the transaction is processed successfully, then the user's payment information is verified and the purchase is completed. In some embodiments, if the user is purchasing the payment device with loyalty points, the online store can verify the loyalty points associated with the user account, deduct the loyalty points, and complete the transaction. Once the transaction is complete, the payment processing computer can request card details from an issuer computer, such as a primary account number (PAN) for the new payment device. The payment processing computer can then send an order to a card printing service that includes the PAN, user name, image, and shipping address.

At step 606, once the online store receives verification that the purchase is complete, the online store can generate a representation of the payment device and notarize the representation. As described above, notarization can include embedding notarization data into the image, such as a watermark. In some embodiments, a verification link can also be included in the notarization process that links to the online store and can verify the authenticity of the image. At step 608, the notarized representation of the payment device is associated with the user's account. This makes the notarized representation visible in the user's card collection.

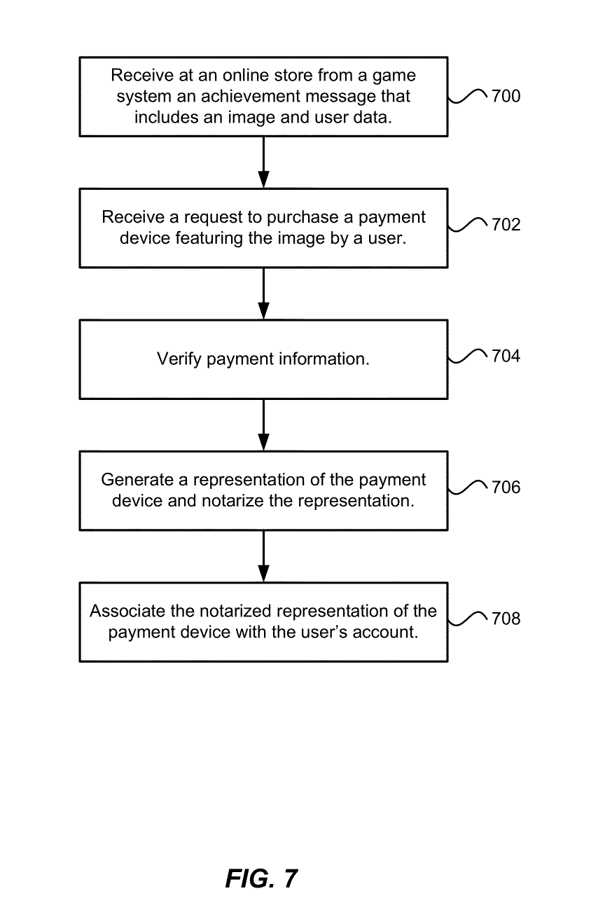

FIG. 7 shows a method of purchasing a payment device with a video game achievement image, in accordance with an embodiment of the invention. At step 700, an online store can receive an achievement message from a game system. The achievement message can include an image and user data such as a user name, shipping address, email address, and/or payment information. In some embodiments, the image can be an image that was captured live in-game by a game system, an image stored at the game system that is associated with the achievement, or an image identifier that can be used to unlock an achievement image stored in an image catalog at the online store. At step 702, the online store can receive a request to purchase a payment device featuring the image received in the achievement message. In some embodiments, if payment information was included in the achievement message, the request can automatically complete the purchase transaction. In some embodiments, in response to the request, a message can be sent to the user and displayed on the user computer request payment and/or shipping information. Steps 704-708 can proceed similarly to steps 604-608 of FIG. 6.

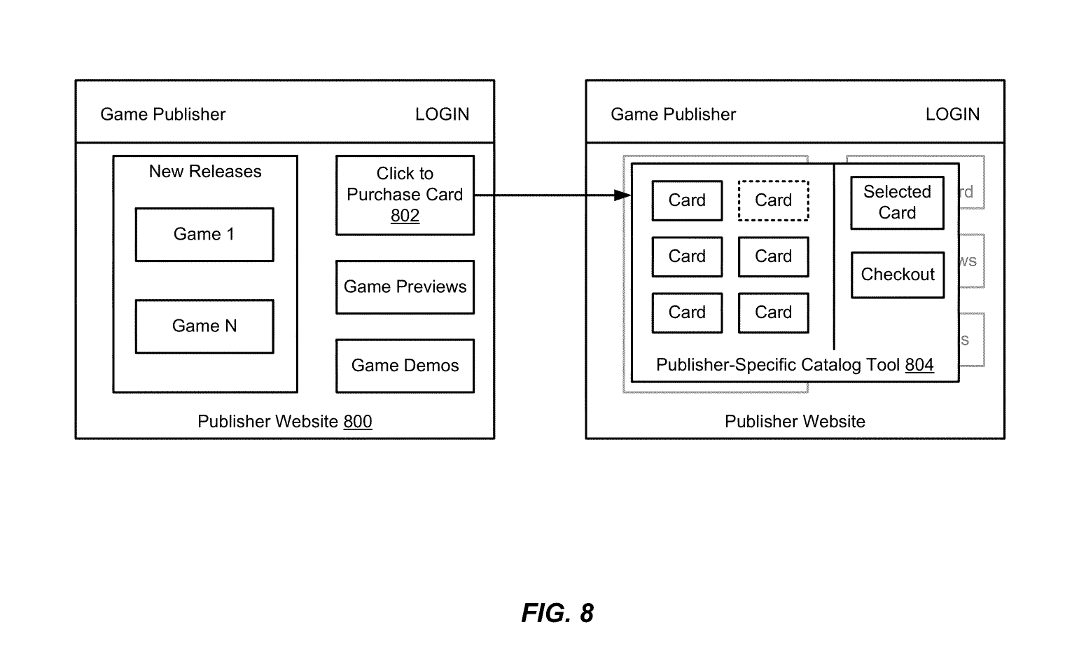

FIG. 8 shows a publisher-specific catalog tool, in accordance with an embodiment of the invention. As described above, game publishers can populate publisher-specific catalogues with images from their video games. Within each publisher-specific catalog, images can also be grouped by video game, genre, etc. Each publisher can embed their catalog on their web site 800, such as by using an HTML widget. By embedding their catalog and linking to the online store, each publisher can enable users to browse the image contents and purchase a payment device featuring one of that publisher's images. In accordance with an embodiment, the embedded catalog can be limited to show only those images associated with that publishers catalog. Each purchase linked through an embedded catalog can be tracked by the online store to determine various purchasing metrics from each embedded catalog. As shown in FIG. 8, the publisher's website 800 can include a link to purchase a card 802. When the link is clicked, the embedded publisher-specific catalog tool 804 can be displayed. The publisher-specific catalog tool 804 can be displayed in a new window or tab, a pop-up, overlay, or any other suitable format. The user can then select and purchase a payment device featuring an image from that publisher's catalog. The procedure for purchasing the payment device and receiving a notarized representation proceeds similarly to that described above with respect to FIGS. 1 and 2.

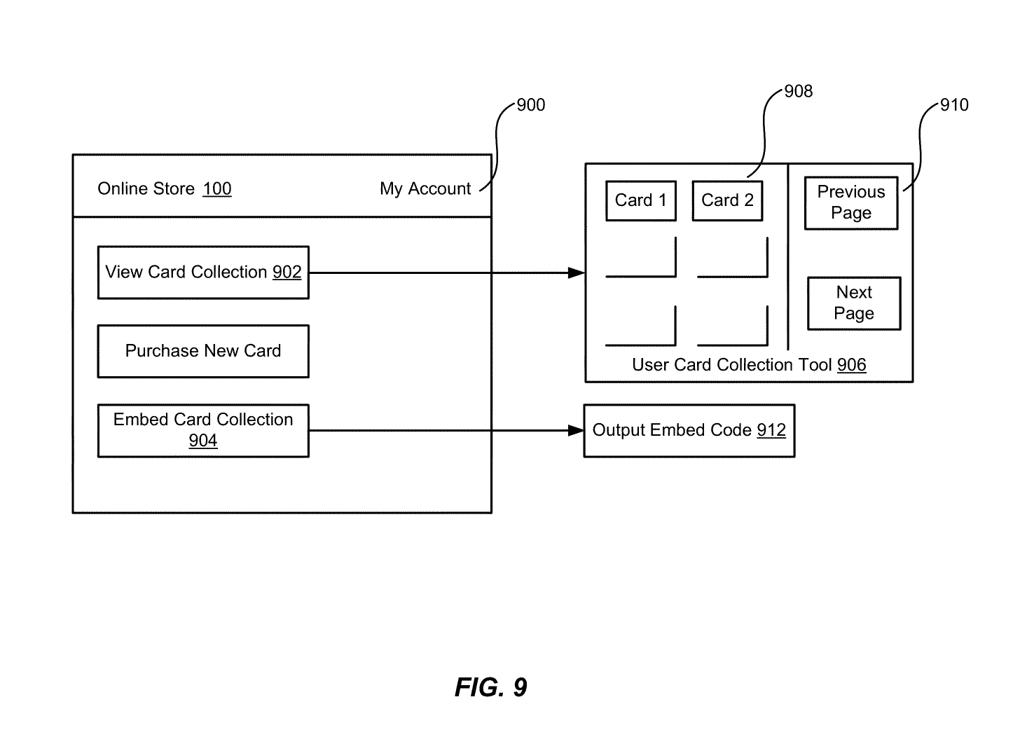

FIG. 9 shows an embeddable user card collection tool, in accordance with an embodiment of the invention. As shown in FIG. 9, the online store 100 can include a view 900 of the user's account. The view 900 can include a link 902 to the user's card collection and a link 904 to embed the user's card collection. Following the link 902 to the user's card collection displays a user card collection tool 906. The user card collection tool 906 can include images 908 of each payment device associated with the user's account. The user can select one of the images to show a full size view of the selected payment device representation. The user card collection tool 906 can further include navigation controls 910 to browse the user's card collection. The link 904 to embed the user's card collection can produce embed code 912 to integrate the user's card collection into one or more social media applications, platforms, blogging tools, etc. This embed code can be provided by the online store to facilitate sharing the notarized representations in a user's collection over different social networks, such as Facebook, Google Plus and Twitter, and blogging platforms. In some embodiments, code can be provided which the user can use to embed the notarized representation into their personal website or social networking page. When the representation is shared, a link can be provided back to the store for those who view the representation to buy their own cards and/or to verify the authenticity of the representations.

In some embodiments, the user card collection tool 906 can indicate the rarity of each representation. The user card collection tool can also analyze the notarized representations owned by the user and make suggestions of other images which may appeal to the user, including both currently available images and images with upcoming release dates. The user card collection tool can also link the user to other users who own similar collections of images and enable the user to follow those other users' collections.

Provided below is a description of an exemplary system in which embodiments provided herein may be utilized. Although some of the entities and components may be depicted as separate, in some instances, one or more of the components may be combined into a single device or location (and vice versa). Similarly, although certain functionality may be described as being performed by a single entity or component within the system, the functionality may in some instances be performed by multiple components and/or entities (and vice versa). Communication between entities and components may comprise the exchange of data or information using electronic messages and any suitable electronic communication medium and method, as described below.

As used herein, an “issuer” may typically refer to a business entity (e.g., a bank or other financial institution) that maintains financial accounts for the user 30 and often issues a payment device 32 such as a credit or debit card to the user 30. As used herein, a “merchant” may typically refer to an entity that engages in transactions and can sell goods or services to the user 30. As used herein, an “acquirer” may typically refer to a business entity (e.g., a commercial bank or financial institution) that has a business relationship with a particular merchant or similar entity. Some entities can perform both issuer and acquirer functions.

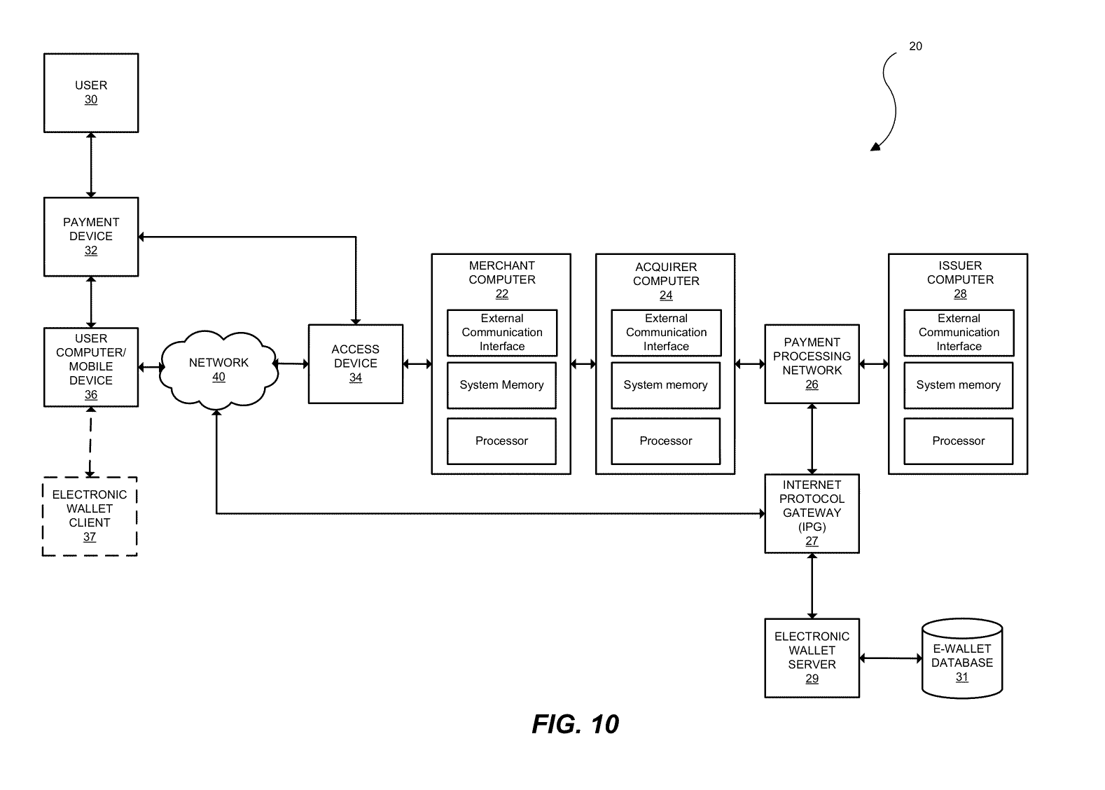

An exemplary financial transaction system is shown in FIG. 10. The system 20 may include one or more merchants, one or more access devices 34, one or more payment devices 32, one or more acquirers, and one or more issuers. For example, the system 20 may include a merchant having a merchant computer 22 that comprises an external communication interface (e.g. for communicating with an access device 34 and an acquirer 24), system memory comprising one or modules to generate and utilize electronic messages, and a data processor (for facilitating a financial transaction and the exchange of electronic messages); an acquirer having an acquirer computer 24 that comprises an external communication interface (e.g. for communicating with a merchant computer 22 and a payment processing network 26), system memory comprising one or modules to generate and utilize electronic messages, and a data processor (for facilitating a financial transaction and the exchange of electronic messages); and an issuer having an issuer computer 28 that comprises an external communication interface (e.g. for communicating with a payment processing network 26), system memory comprising one or modules to generate and utilize electronic messages, and a data processor (for facilitating a financial transaction and the exchange of electronic messages). The external communication interface of the merchant computer 22 may be coupled to an access device 34 (such that information may be received by the access device 34 and communicated to the merchant computer 22) or, in some embodiments, the access device 34 may comprise a component of the merchant computer 22.

As used in this context, an “external communication interface” may refer to any hardware and/or software that enables data to be transferred between two or components of system 20 (e.g., between devices residing at locations such as an issuer, acquirer, merchant, payment processing network 26, etc.). Some examples of external communication interfaces may include a modem, a network interface (such as an Ethernet card), a communications port, a Personal Computer Memory Card International Association (PCMCIA) slot and card, or the like. Data transferred via external communications interface may be in the form of signals which may be electrical, electromagnetic, optical, or any other signal capable of being received by the external communications interface (collectively referred to as “electronic signals” or “electronic messages”). These electronic messages that may comprise data or instructions may be provided between one or more of the external communications interface via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable method.

As would be understood by one of ordinary skill in the art, any suitable communications protocol for storing, representing, and transmitting data between components in the system 20 may be used. Some examples of such methods may include utilizing predefined and static fields (such as in core TCP/IP protocols); “Field: Value” pairs (e.g. HTTP, FTP, SMTP, POP3, and SIP); an XML based format; and/or Tag-Length-Value format.

As shown in the exemplary system 20 in FIG. 10, information from the payment device 32 may be provided to access device 34 either directly (e.g. through a contact or contactless interface) or indirectly thorough a user computer or mobile device 36 (e.g. in an e-commerce environment or other indirect transaction) via network 40 (such as the Internet). In some embodiments, the user computer or mobile device 36 may interact with the payment processing network 26 (or other entity in the system 20) via the network 40 to form a first communications channel, such as through an Internet Protocol Gateway (IPG) 27. The IPG 27 may be in operative communication with the payment processing network 26. Although the IPG 27 is shown as being a separate entity in FIG. 10, the IPG 27 could be incorporated into the payment processing network 26, or could be omitted from the system 20. In the latter situation, the first communications channel could directly connect the payment processing network 26 and the user computer or mobile device 36. In general, providing communication from the user 30 to the payment processing network or other entity may enable a variety of increased functionalities to the user 30, such as advanced authentication and verification methods (particularly in e-commerce and similar transactions), examples of which are described in U.S. Ser. No. 12/712,148 filed on Jul. 16, 2010 and U.S. Ser. No. 13/184,080 filed on Jul. 15, 2011, each of which is incorporated by reference herein in its entirety. However, embodiments are not so limited.

In some embodiments, an electronic or digital wallet (i.e. “e-Wallet”) may be utilized as a payment device for conducting a financial transaction. As shown in FIG. 10, such exemplary systems may comprise an electronic wallet server 29, which may be accessible to the user 30 via network 40 (either directly connected or through an IPG 27) and may also be in operational communication with a merchant and/or with a payment processing network 26 (or in some embodiments, the electronic wallet server 29 may comprise a part of the payment processing network 26). The electronic wallet server 29 may be programmed or configured to provide some or all of the functionality associated with conducting transactions using an electronic wallet, including maintaining an association between the user's e-wallet and one or more payment accounts (such as a bank account or credit card account) in E-Wallet database 31. To provide electronic wallet services (i.e. the use of the electronic wallet associated with a payment account to conduct a financial transaction), the electronic wallet server 29 may further provide a web interface (e.g. through one or more web pages) to receive and transmit requests for payments services and/or may provide an application program interface (API) (shown as electronic wallet client 37) at the user computer apparatus 36 to provide the web service. This process is described in more detail in U.S. Ser. No. 61/466,409 filed on Mar. 22, 2011, which is incorporated herein by reference in its entirety.

As noted above, the user's electronic wallet may be stored in the E-Wallet database 31, which may include information associated with the user's payment accounts can be used in conducting a financial transaction with a merchant. For example, the E-Wallet database 31 may include the primary account numbers of one or more payment accounts (e.g., payment accounts associated with a credit card, debit card, etc.) of the user 30. The e-wallet may be populated with such information during an initial enrollment process in which the user 30 enters information regarding one or more of the payment accounts that may be associated with various issuers. Once the payment account information is added to the E-Wallet database 31, the user 30 may perform transactions by utilizing only his e-wallet. When a user 30 performs a transaction using his electronic wallet, the user 30 need not provide the merchant with payment account information, but may instead provide the electronic wallet information. This information may then be included in an authorization request message, which in turn may be provided to payment processing network 26. The payment processing network 26 may then access the user's e-wallet via a request to the electronic wallet server 29, or may have direct access to the e-wallet database 31 so as to obtain the corresponding payment account information indicated by the information in the authorization request message.

The electronic wallet client 37 may comprises any suitable software that provides front end functionality of the electronic wallet to the user 30. For example, the electronic wallet client 37 may be embodied as a software application downloadable by a computer apparatus or mobile device 32 (e.g., a mobile phone). In some instances, the electronic wallet client 37 may provide a user interface (such as a series of menus or other elements) that allows the user 30 to manage his electronic wallet(s) (i.e. the electronic wallet client 37 may enable interaction with the electronic wallet server 29, and thereby the e-wallet database 31). In some embodiments, the electronic wallet client 37 may store data in a computer readable memory for later use, such as user 30 preferences or identifiers associated with funding sources added to the electronic wallet.

A payment processing network 26 may be disposed between the acquirer computer 24 and the issuer computer 28 in the system 20. The components of an exemplary payment processing network 26 are described below with reference to FIG. 11 for illustration purposes. Furthermore, the merchant computer 22, the acquirer computer 24, the payment processing network 26, and the issuer computer 28 may all be in operative communication with each other (i.e. although not depicted in FIG. 10, one or more communication channels may exist between each of the entities, whether or not these channels are used in conducting a financial transaction).

The payment processing network 26 may include data processing subsystems, networks, and operations used to support and deliver authorization services, exception file services, and clearing and settlement services. For example, the payment processing network 26 may comprise a server computer, coupled to a network interface (e.g. by an external communication interface), and a database(s) of information. An exemplary payment processing network may include VisaNet™, CYBERSOURCE, AUTHORIZE.NET, PLAYS PAN, etc. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 26 may use any suitable wired or wireless network, including the Internet.

Although many of the data processing functions and features of some embodiments may be present in the payment processing network 26 (and a server computer therein), it should be understood that such functions and features could be present in other components such as the issuer computer 28, and need not be present in the payment processing network 26, or a server computer therein.

With reference to FIG. 11, an exemplary server computer 1100 is shown. The exemplary server computer 1100 is illustrated as comprising a plurality of hardware and software modules (1101-1109). However, it should be appreciated that this is provided for illustration purposes only, and each of the modules and associated functionality may be provided and/or performed by the same or different components. That is, exemplary server computer 1100 may, for example, perform some of the relevant functions and steps described herein with reference to the online store through the use of any suitable combination of software instructions and/or hardware configurations. It should be noted that although FIG. 11 illustrates modules located on a single device, the disclosure is not meant to be so limited. Moreover, a system for implementing the functionality described herein may have additional components or less then all of these components. In some embodiments, some modules may be located on other devices such as a remote server or other local devices that are functionally connected to the server computer component(s).

The exemplary server 1100 is shown as comprising a processor 1101, system memory 1102 (which may comprise any combination of volatile and/or non-volatile memory such as, for example, buffer memory, RAM, DRAM, ROM, flash, or any other suitable memory device), and an external communication interface 1103. Moreover, one or more of the modules 1104-1109 may be disposed within one or more of the components of the system memory 1102, or may be disposed externally. As was noted above, the software and hardware modules shown in FIG. 11 are provided for illustration purposes only, and the configurations are not intended to be limiting. The processor 1101, system memory 1102 and/or external communication interface 1103 may be used in conjunction with any of the modules described below to provide a desired functionality. Some exemplary modules and related functionality may be as follows:

The communication module 1104 may be configured or programmed to receive and generate electronic messages. When an electronic message is received by the server computer 1100 via external communication interface 1103, it may be passed to the communications module 1104. The communications module 1104 may identify and parse the relevant data based on a particular messaging protocol. The received information may comprise, for instance, identification information, transaction information, and/or any other information may be utilized in a financial transaction. The communication module 1104 may then transmit any received information to an appropriate module within the server computer 1100 (e.g. via a system bus line 1150). The communication module 1104 may also receive information from one or more of the modules in server computer 1100 and generate an electronic message in an appropriate data format in conformance with a transmission protocol so that the message may be sent to one or more components within a system (e.g. to an issuer computer or merchant computer). The electronic message may then be passed to the external communication interface 1103 for transmission. The electronic message may, for example, comprise an authorization response message (e.g. to be transmitted to a merchant conducting a transaction) or may be an authorization request message to be transmitted or forwarded to an issuer.

The database look-up module 1105 may be programmed or configured to perform some or all of the functionality associated with retrieving information from one or more databases 1110. In this regard, the database look-up module 1105 may receive requests from one or more of the modules of server 1100 (such as communication module 1104, authorization module 1108, or settlement module 1109) for information that may be stored in one or more of the databases 1110. The database look-up module 1105 may then determine and query an appropriate database. The database update module 1106 may be programmed or configured to maintain and update the databases 1110, such as authorization database 1115. In this regard, the database update module 1106 may receive information about a user, financial institution, a payment device, and/or current or past transaction information from one of the modules discussed herein. This information may then be stored in the appropriate location in the database 1110 using any suitable storage process.

The report generation module 1107 may be programmed or configured to perform some or all of the functionality associated with generating a report regarding a user, an account, a transaction or transactions, or any other entity or category of information. This may include, for instance, identifying patterns (such as patterns that indicate a fraudulent transaction or transactions) and generating one or more alerts that may be sent (e.g. via communication module 1104 and external communication interface 1103) to one or more entities, including the user, merchant, or issuer. The report generation module may also, for example, request information from one or more of the databases 1110 via database look-up module 1105.

The authorization module 1108 may be configured or programmed to perform some or all the functionality associated with authorizing a financial transaction associated with an authorization request message. The authorization module 1108 may, for instance, be programmed or configured to compare the information received by via the authorization request message with stored information at the server 1100 or a database 1110 (such as comprising verification values). In some embodiments, if the received and stored values match, the authorization module 1108 may authorize the transaction (or may be more likely to authorize the transaction) and may instruct the communication module 1101 to generate an authorization response message. The authorization module 1107 may also be programmed or configured to execute any further operations associated with a typical authorization.

The server computer may have access to one or more databases 1110, such as authorization database 1115. Each of the databases shown in this example may comprise more than one database, and may be located in the same location or at different locations. The authorization database 1115 may contain information related to a payment device and/or a payment account, as well as any other suitable information (such as transaction information) associated with the payment account.

The user accounts database 1120 and the images catalog database 1122 are described above with respect to FIGS. 1-9.

Provided below are descriptions of some devices (and components of those devices) that may be used in the systems and methods described above. These devices may be used, for instance, to receive, transmit, process, and/or store data related to any of the functionality described above. As would be appreciated by one of ordinary skill in the art, the devices described below may have only some of the components described below, or may have additional components.

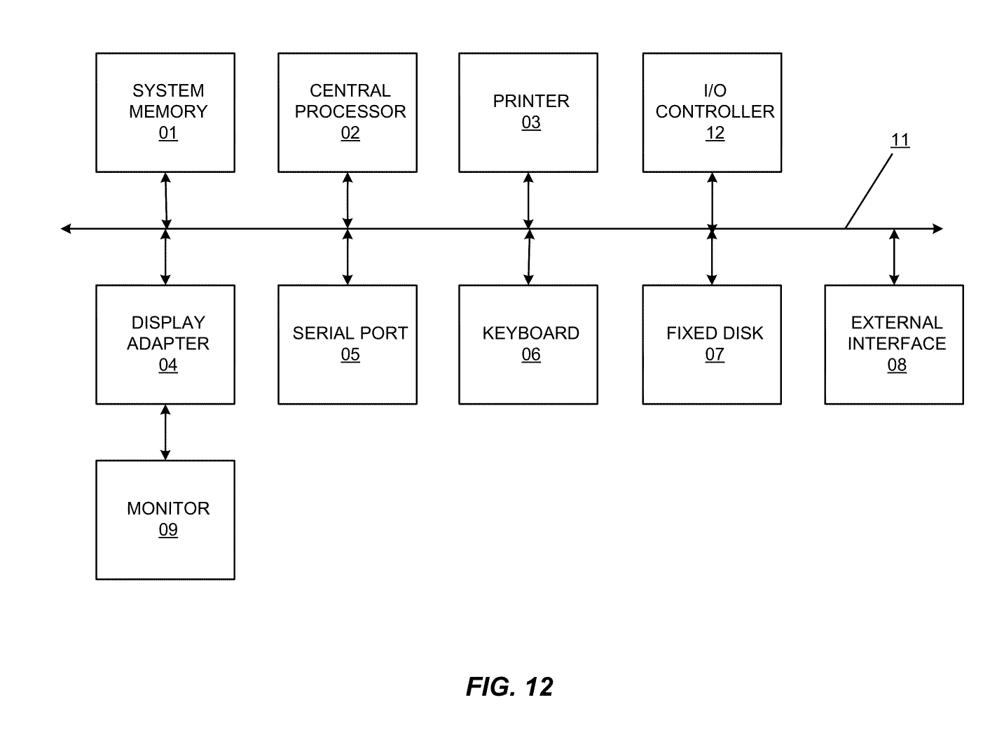

FIG. 12 illustrates exemplary elements of a computer apparatus. As noted above, the various participants and elements shown in FIGS. 1-9 can operate one or more computer apparatuses to facilitate the functions described herein. As would be appreciated by one of skill in the art after reading this disclosure, any of the elements in FIGS. 1-9 can use any suitable number of systems and subsystems to facilitate the functions described herein. Moreover, each of the systems and subsystems may comprise any number of hardware and software modules, such as those described above.

Examples of such systems, subsystems, and components are shown in FIG. 12. The subsystems and components shown in FIG. 12 are interconnected via a system bus 11. Additional subsystems such as a printer 03, keyboard 06, fixed disk 07 (or other memory comprising computer readable media), monitor 09, which is coupled to display adapter 04, and others are shown. Peripherals and input/output (I/O) devices, which coupled to I/O controller 12, can be connected to the computer system by any number of means known in the art, such as serial port 05. For example, serial port 05 or external interface 08 can be used to connect the computer apparatus to a wide area network such as the Internet, a mouse input device, or a scanner. The interconnection via system bus allows the central processor 02 to communicate with each subsystem and to control the execution of instructions from system memory 01 or the fixed disk 07, as well as the exchange of information between subsystems. The system memory 01 and/or the fixed disk 07 can embody a computer readable medium.

With reference to FIG. 13, a block diagram of an exemplary mobile device 36 is shown that may be used in some embodiments. In some embodiments, the mobile device 36 may be a notification device that can receive alert messages, a payment device that can be used to make payments, an access device (e.g. POS device) that may receive information from a consumer to conduct a transaction, and/or a multi-purpose general use device. The exemplary mobile device 36 shown in FIG. 13 may comprise a computer readable medium 36(b) that be present within the body (or outer casing) 36(h), or the computer readable medium 36(b) could be detachable from the device (e.g. the computer readable medium 36(b) could comprise an external memory that could be connected through a physical interface such as a USB connection, or the data could be hosted remotely and accessed wirelessly by the device—e.g. the data could be hosted and stored at a remoter server in the “cloud”). The computer readable medium 36(b) may be in the form of a memory that stores data. The memory may store information such as financial information, transit information (e.g., as in a subway or train pass), access information (e.g., access badges), serial numbers, mobile account information, and any other suitable information. In general, any of this information may be transmitted by the mobile device 36 (such as to an access device 34), via any suitable method, including the use of antenna 36(a) or contactless element 36(g). The body 36(h) may be in the form a plastic substrate, housing, or other structure.

In some embodiments, the mobile device 36 may further include a contactless element 36(g), which is typically implemented in the form of a semiconductor chip (or other data storage element) with an associated wireless transfer (e.g., data transmission) element, such as an antenna. Contactless element 36(g) may be coupled to (e.g., embedded within) the mobile device 36 and data or control instructions that are transmitted via a cellular network may be applied to the contactless element 36(g) by means of a contactless element interface (not shown). The contactless element interface functions to permit the exchange of data and/or control instructions between the mobile device circuitry and an optional contactless element 36(g), or between another device having a contactless element (e.g. a POS terminal or a payment device). Contactless element 36(g) may be capable of transferring and receiving data using a short range wireless communication capability. As noted above, mobile device 36 may comprise components to both be the interrogator device (e.g. receiving data) and the interrogated device (e.g. sending data). Thus, the mobile device 36 may be capable of communicating and transferring data or control instructions via both cellular network (or any other suitable wireless network—e.g. the Internet or other data network) and short range communications.

The mobile device 36 may also include a processor 36(c) (e.g., a microprocessor) for processing the functions of the phone 36 and a display 36(d) to allow a consumer to see phone numbers and other information and messages. The mobile device 36 may further include input elements 36(e) to allow a user to input information into the device, a speaker 36(f) to allow the user to hear voice communication, music, etc., and a microphone 36(i) to allow the user to transmit her voice through the mobile device 36. The mobile device 36 may also include an antenna 36(a) for wireless data transfer (e.g., data transmission).

FIG. 14 shows an example of a payment device 32″ in the form of a card. As shown, the payment device 32″ comprises a plastic substrate 32(m). In some embodiments, a contactless element 32(o) for interfacing with an access device 34 may be present on, or embedded within, the plastic substrate 32(m). Consumer information 32(p) such as an account number, expiration date, and/or a user name may be printed or embossed on the card. A magnetic stripe 32(n) may also be on the plastic substrate 32(m). In some embodiments, the payment device 32″ may comprise a microprocessor and/or memory chips with user data stored in them.

As noted above and shown in FIG. 14, the payment device 32″ may include both a magnetic stripe 32(n) and a contactless element 32(o). In some embodiments, both the magnetic stripe 32(n) and the contactless element 32(o) may be in the payment device 32″. In some embodiments, either the magnetic stripe 32(n) or the contactless element 32(o) may be present in the payment device 32″.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

As noted previously, all measurements, dimensions, and materials provided herein within the specification or within the figures are by way of example only.

A recitation of “a,” “an,” or “the” is intended to mean “one or more” unless specifically indicated to the contrary. Reference to a “first” component does not necessarily require that a second component be provided. Moreover reference to a “first” or a “second” component does not limit the referenced component to a particular location unless expressly stated.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

What is claimed is:

1. A server computer comprising:
a computer readable storage medium and processor;
an image catalog, wherein the image catalog is a database including a plurality of images;
an online store, executing on the processor, wherein the online store is configured to
receive a selection of an image to be printed on a payment device;
receive a request to purchase a payment device, wherein the request indicates an image to be displayed on the payment device;
notarize a representation of the payment device configured to display the image; and
associate the payment device and the representation of the payment device with a user account.

2. The server computer of claim 1, wherein notarizing a representation of the payment device configured to display the image, comprises:
embedding authentication information into the representation of the payment device.

3. The server computer of claim 2, wherein the authentication information is a visible watermark.

4. The server computer of claim 1, further comprising:
a user card collection that includes the notarized representation of the payment device and further includes notarized representations of a plurality of different payment devices associated with the user account.

5. The server computer of claim 1, wherein the image is selected from the image catalog through the online store, and wherein the plurality of images are from a plurality of different video games.

6. The server computer of claim 1, wherein the image is an achievement image received from a game system, wherein the achievement image is captured by the game system upon completion of the achievement in a video game.

7. The server computer of claim 6, wherein the achievement image is predefined by the game system and a message is sent by the game system to the online store to make the achievement image available for selection.

8. A system comprising:
a host computer comprising a computer readable storage medium and processor, wherein the host computer includes an image catalog, and wherein the host computer is configured to
receive a selection of an image to be printed on a payment device from a client computer,
receive a request to purchase a payment device, wherein the request indicates an image to be displayed on the payment device,
notarize a representation of the payment device configured to display the image, and
associate the payment device and the representation of the payment device with a user account; and
the client computer comprising a display component configured to display images in the image catalog, receive the selection of the image and send the selection of the image to the host computer.

9. The system of claim 8 further comprising:
a game system configured to communicate with the client computer and the host computer, wherein when the game system determines that a user has achieved an achievement, the game system sends an achievement message to the host computer;
wherein the host computer is further configured to
receive the achievement message from a game system indicating the achievement earned by the user and further including an achievement image and user data;
receive a request from a client computer to purchase a payment device, wherein the request indicates the achievement image associated to be displayed on the payment device; and
generate a representation of the payment device configured to display the achievement image, and
associate the payment device and the representation of the payment device with a user account; and
wherein the client computer is further configured to execute one or more video games, receive the request to purchase the payment device, and send the request to the host computer.

10. A method, comprising:
receiving, at an online store executing on a computer including a computer readable medium and processor, an achievement message indicating an achievement earned by a user and further including an achievement image and user data;
receiving, at the online store, a request from the user to purchase a payment device, wherein the request indicates the achievement image associated to be displayed on the payment device; and
generating, by the online store, a representation of the payment device configured to display the achievement image.

11. The method of claim 10, further comprising:
notarizing the representation of the payment device including the achievement image.

12. The method of claim 11, wherein notarizing the representation of the payment device including the achievement image includes providing an authentication link to the online store.

13. The method of claim 11, wherein notarizing the representation of the payment device and the copy of the achievement image, comprises:
embedding authentication information into the representation of the payment device and the copy of the achievement image.

14. The method of claim 12, wherein the authentication information is a visible watermark.

15. The method of claim 12, further comprising:
updating a user card collection to include the notarized representation, wherein the collection widget can include notarized representations of a plurality of different payment devices associated with the user account.

16. The method of claim 10, further comprising:
sending the representation of the payment device to a notarization service to be notarized, wherein notarization includes embedding authentication information into the representation of the payment device; and
receiving from the notarization service and notarized representation of the payment device.

17. The method of claim 11, wherein the achievement image is stored in an achievement database, and wherein the achievement database can include a plurality of achievement images associated a plurality of video games.

18. The method of claim 16, wherein the user can select only achievement images associated with achievements earned by the user.

19. The method of claim 11, wherein the achievement image is received from a game system, wherein the game system captures the achievement image and sends it to the online store using an image capture API.

20. The method of claim 11, further comprising:
receiving payment information to purchase the payment device;
sending purchase information, including the payment information, user information, and the image to a payment processing computer, wherein the payment processing computer completes the purchase and requests payment device data from an issuer computer; and
receiving an indication from the payment processing computer that the purchase has been completed, wherein the payment processing computer sends payment device order details to a payment device production service, wherein the payment device order details include the purchase information and the payment device data.
